(19) United States
(12) Patent Application Publication
(10) Pub. No.: US 2016/0171912 A1
(43) Pub. Date: Jun. 16, 2016

(54) WHATSNTHATBOX

(71) Applicant: Jabbar Washington, Minneapolis, MN (US)

(72) Inventor: Jabbar Washington, Minneapolis, MN (US)

(21) Appl. No.: 14/568,276

(22) Filed: Dec. 12, 2014

(51) Int. Cl. G09F 3/02

(52) U.S. Cl. CPC G09F 3/02; G09F 2003/0208; G09F 2003/0216

(57) ABSTRACT

The invention provides an innovative way to organize, store, retrieve, customize, and save time when looking for shoes when stored in shoeboxes or boxed storage systems. The invention includes detailed life like pictures of every shoe in color, as well as text and information in a written form that combine to tailor every sticker to fit the customer's needs, thus saving them time and energy while searching for shoes. The invention also reduces wear and tear on boxes created by opening boxes often to its content. The invention reduced wear and tear, increases organization, reduces search time, and customizes every collection

### BACKGROUND OF INVENTION

The invention is created and intended to provide an innovative way to organize, store, locate the specific shoe in every shoebox or storage system that you own. This invention differs from any other item on the market because it uses the combination of color pictures, text and art to create a shoe sticker/label that allows users to locate, customize and organize their entire shoe collection.

This invention also provides a product that aids in the reduction of wear and tear on shoeboxes or any boxed storage device as well as the actual shoe itself. The invention saves time, energy, and makes every collection one of a kind. Shoe stores, boutiques, and distribution facilities use the invention to assist with organization of produce is and save them countless hours when tying to track down shoes and products while serving customers, reducing the time it takes to find the exact shoe they are trying to identify without having to read the fine print and confusing information on every box. The invention provides a clear color image/picture and written description of the contents in the box.

I en vision large shoe stores using the invention in several different ways. The invention dramatically increase the efficiency of workers when locating shoes for customers and the stores ability to organize and track inventory. Companies also use this as a marketing tool (business card on every box) where they include information that might be located on a business card to act as a resource for customers or anyone viewing the box or it contents. (Shoe Image Company Name, Address, phone) Companies can also use one of a kind stickers to distinguish themselves from their competition.

### BRIEF SUMMARY OF INVENTION

This invention provides a new and innovative way to customize, organize, and track shoes in a box or boxed storage device making it one of a kind. This invention allows users the ability to store, organize, and track their collection without having to read the small print on shoe boxes which can be tedious and time consuming by simply applying a colorful detailed sticker of the shoe inside the box that way enabling the shoe to be quickly identified.

### BRIEF DESCRIPTION OF DRAWINGS

FIG. 1: A Front view of the show label with a picture of the shoe in the box as well as the customer's name.

FIG. 1-1: is an example of the shoe, in the box, that would be displayed on the label

FIG. 1-2: Is the name of the customer

FIG. 2: A Front view of the shoe label with a picture of the shoe in the box and the name of the shoe.

FIG. 2-1: Is an example of the shoe, in the box, that would be displayed on the label

FIG. 2-2: Is the name of the shoe

FIG. 3: A Front view of the shoe label with a picture of the shoe in the box and the name of the shoe and the name of company who created the show label (What's In The Box)

FIG. 3-1: Is an example of the shoe, in the box, that would be displayed on the label

FIG. 3-2: Is the name of the shoe

FIG. 3-3: The name of company who created the shoe label (What's In The Box)

FIG. 4: A Front view of the shoe label with a picture of the shoe in the box and the name of the name of company who created the shoe label (What's In The Box)

FIG. 4-1: The name of the company who created the shoe label

FIG. 4-2: Is an example of the shoe, in the box, that would be displayed on the label

FIG. 5: A view of a shoe box with the label of the shoe placed on the side of the shoe box, with the name of the shoe underneath the picture of the shoe.

FIGS. 6, 7, 8,& 9: Views of a shoe box with the label of the shoe placed on the side of the shoe box.

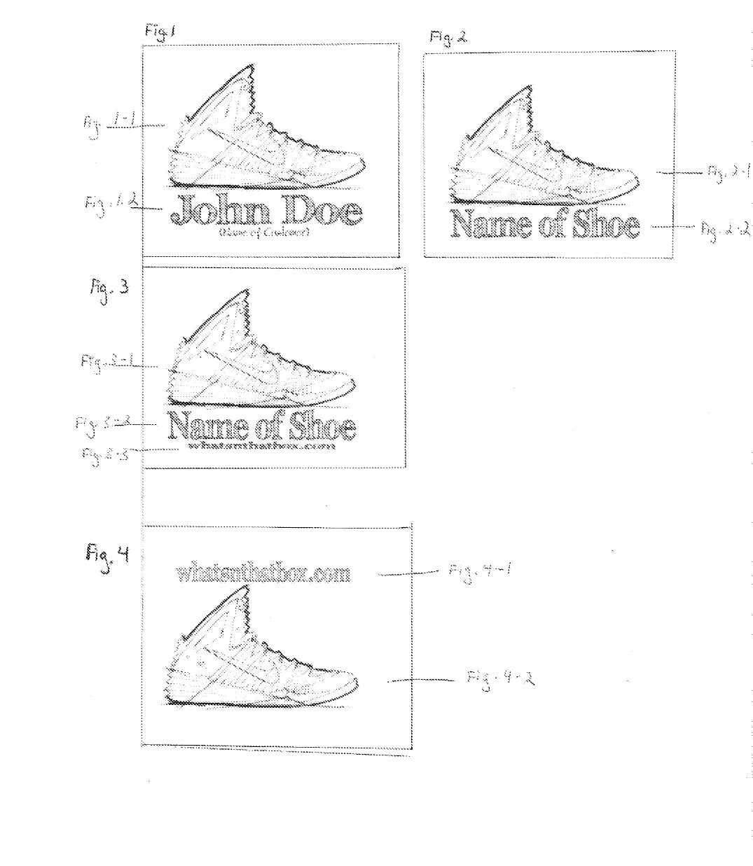

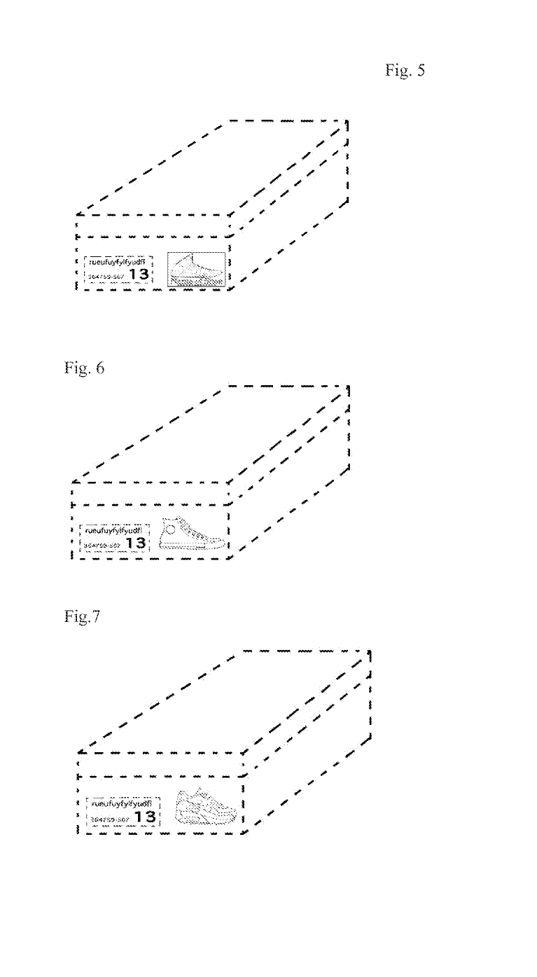

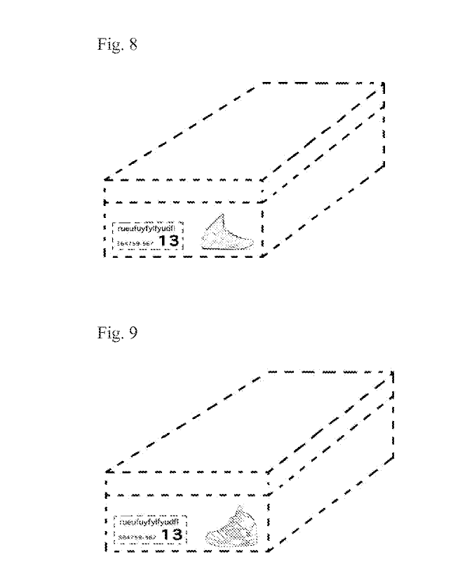

1) A shoe label was conceived and designed by inventor comprising of a sticker created on glossy, plain, and colored paper ranging in size from 2×2- 11/16, 3×3, 2×2½, ¼, 3×3 and 1/7.

2) The shoe label from claim one, further comprising of a colored picture of the shoe that is inside the shoebox.
